(19) United States
(12) Patent Application Publication
(10) Pub. No.: US 2013/0238409 A1
(43) Pub. Date: Sep. 12, 2013

(54) Vehicle Display Device And Uses Thereof

(71) Applicants: Manjirnath Chatterjee, San Francisco, CA (US); Zurvan Mahamedi, San Carlos, CA (US)

(72) Inventors: Manjirnath Chatterjee, San Francisco, CA (US); Zurvan Mahamedi, San Carlos, CA (US)

(21) Appl. No.: 13/533,949

(22) Filed: Jun. 26, 2012

Related U.S. Application Data
(60) Provisional application No. 61/608,656, filed on Mar. 9, 2012.
(60) Provisional application No. 61/615,778, filed on Mar. 26, 2012.

(51) Int. Cl. H04N 5/64; G06Q 30/02

(52) U.S. Cl. 705/14.4; 348/837; 348/E05.128

(57) ABSTRACT

A vehicle display device includes a display surface, a wireless receiver to communicate with a source, and a processing resource that receive content from the source. A coupling mechanism is provided with the display surface to attach the display surface to the vehicle to overlay or replace a surface of the vehicle.

### RELATED APPLICATIONS

This application claims benefit of Provisional U.S. Patent Application No. 61/608,656, filed Mar. 9, 2012; the aforementioned application being hereby incorporated by reference in its entirety.

This application also claims benefit of Provisional U.S. Patent Application No. 61/615,778, filed Mar. 26, 2012; the aforementioned application being hereby incorporated by reference in its entirety.

### TECHNICAL FIELD

Embodiments described herein pertain to a vehicle display device and uses thereof.

### BACKGROUND

Vehicles, such as passenger cars, typically carry little or no exterior content other than stickers, license plate information and occasional signage. Such content is usually static, and in many cases, permanent (e.g., painted on the vehicles).

### BRIEF DESCRIPTION OF THE DRAWINGS

FIG. 1A illustrates a vehicle display device for use with a vehicle, according to an embodiment.

FIG. 1B illustrates a vehicle communication system that provides for a vehicle that uses a vehicle display device, under an embodiment.

FIG. 2 illustrates a system for displaying content on vehicle display devices of vehicles, according to one or more embodiments.

FIG. 3A illustrates a method for operating an interface to enable advertisers to list or provide promotional content for drivers, according to an embodiment.

FIG. 3B illustrates a method for enabling a driver or end user to receive content for display on a display unit of the driver, according to an embodiment.

FIG. 3C illustrates a method for compensating a driver for including promotional content on a display device of the driver's vehicle, according to an embodiment.

FIG. 3D illustrates a method for providing promotional content on vehicles, according to one or more embodiments.

FIG. 4A illustrates an example of a vehicle display device with content provided from a service such as described with an embodiment of FIG. 2.

FIG. 4B illustrates another example implementation of a vehicle display device.

FIG. 4C illustrates another example implementation of a vehicle display device.

FIG. 5 illustrates examples for using vehicle display devices that can detect other vehicle display devices, according to one or more embodiments.

FIG. 6 illustrates an example implementation of a communication protocol for a content display system, according to one or more embodiments.

FIG. 7 is a block diagram that illustrates a computer system upon which embodiments described herein may be implemented.

### DETAILED DESCRIPTION

Embodiments described herein provide a dynamic content display for use on the exterior of vehicles or other environments. In some implementations, the content can be personalized or specific to the driver. In variations, the content can be promotional content, such as in the form of advertisement, brand display or coupons. Still further, in some variations, the content can be generated in response to presence of other content displays on exterior of nearby vehicles.

Still further, some embodiments provide for a system for providing interactive or dynamic displays on cars and in other venues using content that is streamed, messaged or otherwise communicated from a server or service. In some embodiments, a system encompasses mediums for signage that extend to car wheels, wall mounts, and billboards.

Numerous embodiments described herein provide for use of display devices on the exterior of vehicles. In some embodiments, a system and method is described for rendering content on a display device of a vehicle. Still further, some embodiments include a display device for rendering content from a network service on an exterior surface of a vehicle.

In some embodiments, commercial content is provided on display devices that reside on the exterior of vehicles. In particular, commercial content such as advertisements can be rendered on exterior display devices of vehicles. The vehicles can include those operated by non-commercial drivers, such as everyday commuters who operate owned or leased vehicles of their choosing.

In some variations, the commercial content that is displayed can be selected by the user. For example, drivers can select content for display on their vehicles (or rental vehicles) based on their preference for brands, products, aesthetic preferences (e.g., color of content), location of their residence or location where their vehicle is parked or driven.

In variations, content can be in the form of advertisers, or otherwise sponsored. In such embodiments, the advertisers can specify criteria for vehicles that can display their content. For example, an advertiser for a car dealership can exclude vehicles that are of a make or model associated with a competitor. Advertisers may also specify criteria based on a model or class of their vehicle. For example, an advertiser of a luxury service or product may specify content for luxury class vehicles. Still further, advertisers and other content providers can specify criteria such as location, including location of driver (e.g., residence), or location where vehicle is driver or parked etc.

In some embodiments, advertisement and other sponsored content is distributed to a plurality of display devices provided with a fleet of vehicles. The fleet of vehicles can be owned or operated by everyday, non-commercial drivers. In variations, the fleet of vehicles can be part of a rental fleet.

According to embodiments, the drivers (or operators) of the vehicles can be compensated or rewarded for including display devices with commercial content based on exposure parameters, such as distance traveled, route traveled and/or time of day.

Still further, some embodiments include a protocol for use in enabling a network service to communicate with display devices of vehicles. Among other benefits, the network protocol can be optimized for relatively low-bandwidth communications. In variations, the network protocol is optimized for relatively static content that can be changed periodically, such as by the hour, day, or week.

Still further, some described herein provide a system and mechanism by which people can attach (e.g., “snap on,” or otherwise removeably attach) promotional content (e.g., advertisements, coupons, signage) onto various parts of their vehicles as part of an advertising campaign. The promotional content can also be provided as a simple color scheme representing a brand, or brand display, a trademark, or a logo (e.g., “Coca Cola” insignia, the color aqua for Tiffany's). In some embodiments, individuals are enabled to attach the promotional content to their hubcaps of their vehicles (or other parts of their vehicles, such as the bumper or roof).

Some embodiments incorporate additional functional features, such as (i) global positioning system (GPS) tracking, in order to manage advertisement campaigns geographically and/or in order to compensate persons for attaching the content (e.g., used to determine the locations, the amount of time and/or the distance the persons traveled), or (ii) verification systems, in order to ensure that the promotional content has been provided or attached to the persons' vehicle in an exterior location of the vehicle (or in view of someone outside the vehicle), while they are driving, as required.

Some embodiments include a two-portal platform, including a front end portal that allows a customer that needs an ad campaign to buy time by uploading their campaign materials to the front end portal. The back end portal consists of individual users who are compensated for putting the customer's campaign materials on an exterior location of the vehicle, based on a number of hours that they post the promotional content on their vehicle. Additionally, variations provide for a user (e.g., driver or owner of the vehicle) portal (or user access to a front end portal) where the user can request a specific advertisement campaign, merchant or brand (e.g., user may want to sponsor a local business or a national brand).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

Vehicle Display Device

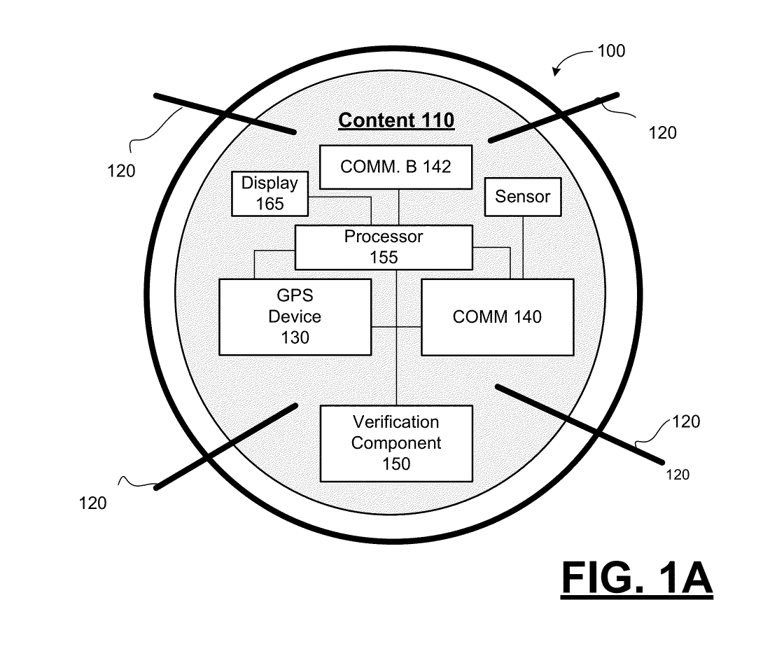

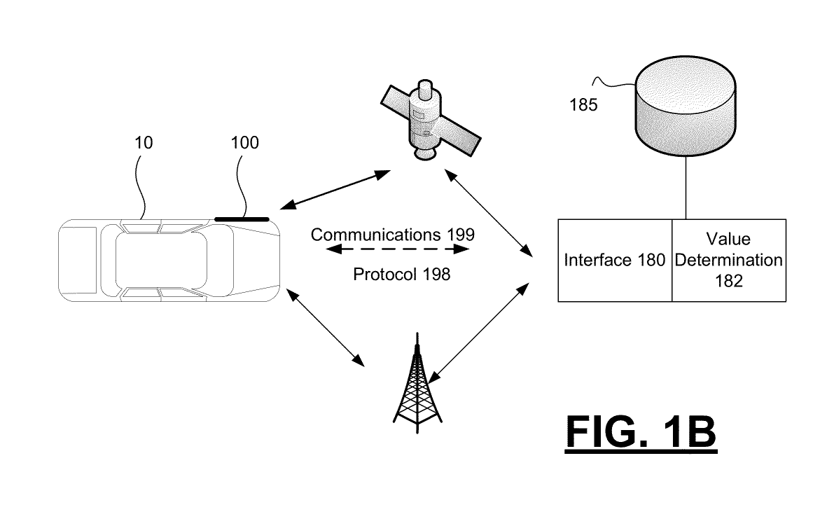

FIG. 1A illustrates a vehicle display device (“VDD”) for use with a vehicle, according to an embodiment. According to some embodiments, the VDD 100 includes a content component 110, an attachment mechanism 120, a GPS communication device 130, one or more communication components 140, 142, and/or processing resources 155. The content component 110 can be mechanical in nature (e.g., hard copy or medium), illumination-based (e.g., cast light), or include display graphic processing resources (e.g., an LCD display and a processor) to generate, for example, promotional content or other sponsored content.

In some embodiments, a verification component 150 may be provided. The verification component 150 includes a sensor to verify the presence and use of the VDD 100. For example, the verification component 150 can detect whether the VDD 100 is provided on the exterior of the user's vehicle, or whether the VDD 100 is properly positioned so that it can be seen by others as the vehicle is driven or parked.

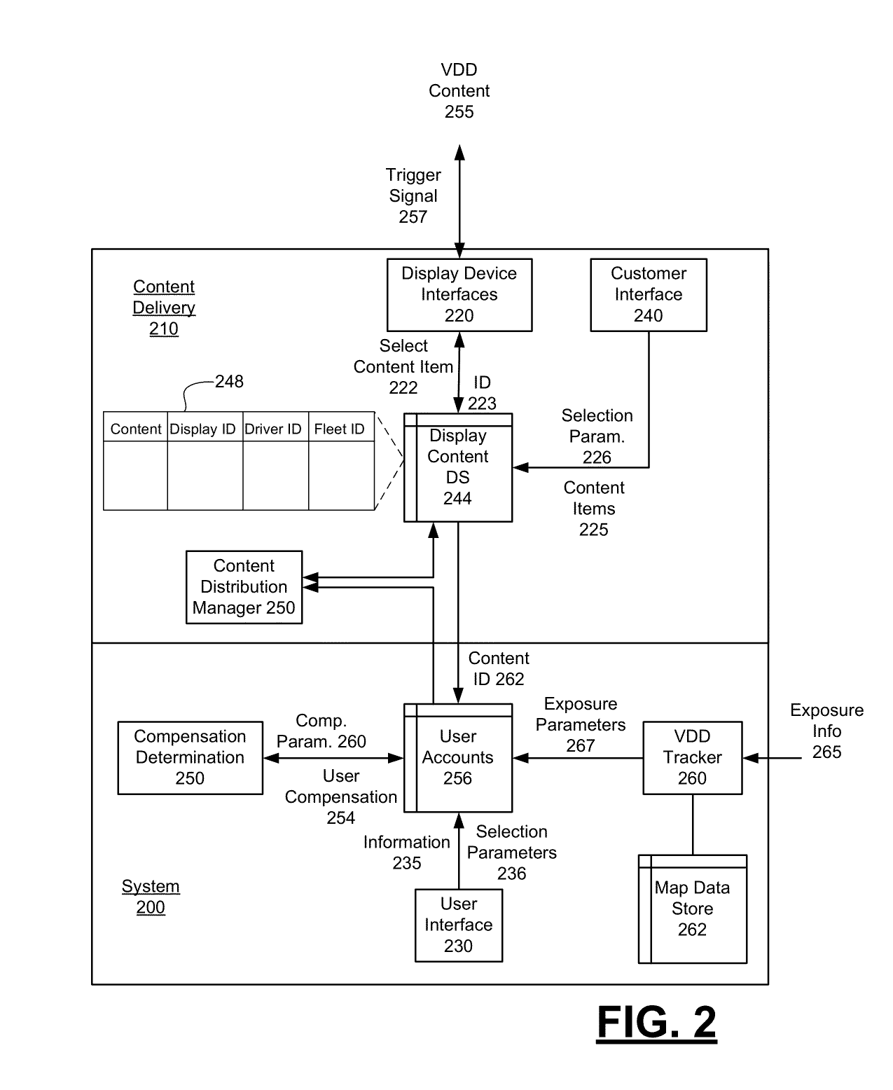

In one implementation, the wireless communication component 140 operates to send and/or receive information to a system hub (e.g., system 200, see FIG. 2). The system hub can correspond to a network location where information about the VDD 100 is maintained. Accordingly, VDD 100 can be structured to transmit and receive data using, for example, a cellular network. In variations, other wireless networks can be used, such as Wireless Fidelity or WiFi networks (e.g., 802.11(b), (g) or (n)).

As an alternative or addition, one or more alternative communication components 142 are integrated or otherwise provided with the VDD 100. In one implementation, the communication component 142 can be used to enable data to be communicated from the VDD 100 to another device (e.g., driver device, such as cellular phone, odometer) within the vehicle. For example, the communication component 142 can enable Bluetooth communications with a cellular telephony device of the driver, or with the odometer of the vehicle. As another variation, the communication component 142 can provide an inductive channel to enable that device to communicate with other similarly equipped devices, including similarly equipped vehicle display devices on other vehicles (e.g., on vehicles that are adjacent to the VDD 100). The communication enabled through the communication component 142 can, for example, (i) provide additional information for the VDD 100, (ii) enable alternative modes of communication between VDD 100 and the system portal, (iii) enable the VDD 100 to utilize resources of the other devices for information such as position information (e.g., use GPS from cell phone, or mileage from vehicle etc.), and/or (iv) enable presence detection, where the VDD 100 can be detected by other devices, or detect other devices. In the latter case, presence detection can be used to enable two VDD devices to detect and communicate with one another.

As another alternative or variation, the communication component 142 can be used to detect and/or communicate with other VDD 100. For example, the communication component 142 can provide a communication resource that detects presence of another VDD 100. For example, when two vehicles carrying VDD 100 drive next to one another, the communication component 142 on each device may detect the other device. In such variations, the communication component 142 can provide, for example, a far-field communication resource, such as provided by a Bluetooth communication resource. As an a variation, the communication component 142 can provide a line of sight communication resource (e.g., Infra-red).

The processing resources 155 can reside on-board with VDD 100, and implement programming or logic (e.g., rules, interfaces with other devices, data). The processing resources 155 can be implemented through, for example, a central processing unit and/or through integrated circuits. At least some of the programming and logic of the processing resources 155 can be pre-configured for the device. In variations, at least some of the programming and logic can be updated remotely, such as through over-the-air updated. In some implementations, the information communicated from the communication component 140 can be determined or otherwise outputted by the processing resources 155.

In some variations, the communication communicated from the communication component 140 can include information determined from other resources of the VDD 100. For example, position or location information can be generated from the GPS device 130, and communicated through the processing resources 155 or directly through the communication component 140 as position information. The position information can, for example, be (i) determined continuously, over a given duration of time, (ii) determined only when the vehicle is on a trip or outside of a residence, (iii) collected continuously by, for example, the processing resources 155, and transmitted in bursts at periodic intervals using the wireless communication component 140.

As alternatives or variations, other forms of information can be communicated from the communication component 140. For example, trip information, such as start position, finish position or distance traveled can be calculated by the processing resources 155 using, for example, position information from the GPS device 130. The trip information can be communicated from, for example, the communication component 140 to a service, such as described with an embodiment of FIG. 2.

Still further, some embodiments provide that the information signaled from the VDD 100 can include information for determining exposure parameters for the content. Such information can include, for example, an identifier of the vehicle and/or user, the position of the vehicle, a mileage or distance traveled by the vehicle as compared to a prior instance (e.g., previous instance when communication was sent), path points for a vehicle trip (e.g., a path traveled by the user and vehicle, a start location, a stop location), the time traveled, as well as other information (e.g., time of day, number of other VDDs encountered). The wireless communication component 140 may utilize, for example, cellular technology, or short-range wireless communication, such as Bluetooth, to communicate with another device that communicates out. For example, the user (e.g., the driver) can track and view data from the VDD 100 by communicating with the wireless communication component 140 via his or her smart phone, personal computer or laptop, or tablet device.

In one embodiment, the verification component 150 includes a camera that takes a picture of the VDD 100 in its environment. In variations, the verification component 150 includes an accelerometer, magnetometer, or other sensors that can detect rotation (for implementations when VDD 100 is mounted to wheel area) or movement. Other logic can correlate the detected rotation with miles traveled by the vehicle.

As an alternative or variation to the GPS component 130, the VDD 100 may integrate or communicate with other geo-aware resources of the vehicle, vehicle accessories, and/or driver. For example, in one variation, the VDD 100 can utilize the communication component 140, or another communication component, to detect another device that has GPS resources. The communication component 140 may interface with another GPS device in order to determine GPS information. For example, the communication component may communicate with a cellular, GPS enabled device of the driver while the vehicle is in motion. As still another variation, the VDD 100 may track distance the vehicle travels by way of counting rotations of the vehicles tires, or by interfacing with an odometer of the vehicle.

According to an embodiment, the VDD 100 can also include a power source (e.g., a rechargeable battery) to provide power to the various components of the VDD 100. The VDD 100 can include a memory resource (e.g., a stored memory resource or a removable memory device, such as FLASH memory) in order to store data detected by the GPS component 130 and the verification component 150.

Among other benefits, embodiments enable accurate measurement of exposure time and/or distance (for both the customer and the drivers) for VDD 100.

According to various embodiments, the components of VDD 100 can provide input that determines a variety of exposure parameters. Examples of exposure parameters can include mileage, duration that the vehicle is in movement, location or route taken by vehicle (e.g., heavily trafficked route), location where vehicle is parked (e.g., street parking) and other parameters.

In some embodiments, a user can be compensated for exposure based on one or more of the exposure parameters provided. For example, a user compensation may be based on the user driving his vehicle a certain number of miles with the VDD 100, as well as the amount of time in which the vehicle ins in flight. Other implementations can extend to compensating the user for parking his car in a busy street, or compensating the user more heavily for driving on more trafficked routes, or routes where the population is more relevant (e.g., affluent, proximate) to the subject of the promotional content. Compensation can be in the form of, for example, monetary compensation, or discounts for credits for products or services.

In some variations, the VDD 100 can include one or more processing resources 155 for controlling, for example, the GPS device 130, communication component 140 or verification component 150. In variations, the GPS device 130, communication component 140, and/or verification component 150 operate independently, and communicate data to one another.

In an embodiment, a display component 165 or other illumination resource is provided to output component. The display component can be an Light Emitting Diode (LED) display, Liquid Crystal Display (LCD) LCD display, vacuum fluorescent display or variants thereof. Thus, content 110 can be computer generated and rendered through, for example, display component 165. The processing resource 155 can include logic or other resources to drive the display component 165. Input for content that is to be rendered can be stored locally or received over the communication component 140. Sensors, such as light sensors (e.g., detect street parking versus garage), or accelerometers (e.g., detect rotation) can interface with the processing resource 155 or include self-contained logic for communicating with, for example, the communication component 140.

The processing resources 155 may include, or receive display logic that can affect content displayed through the display component 165. For example, the display component 165 can generate content which is transitional (e.g., so as to appear to be moving). Transitional content can, for example, move from left-to-right, or right-to-left. Other display effects include, for example, the displayed content fading or dissolving.

In some embodiments, the hub VDD 100 includes smart-up functionality that persistently maintains the promotional content right side up when the hubcap of the vehicle is in motion. In one embodiment, this functionality is provided with mechanical “up” contrivance. In other implementation, the functionality can be provided through use of an electronic rotating display. For example, display component may rotate independently using a rotational mechanism (e.g., motor), and be coupled with a gravity sensor to always maintain right side up appearance.

While an embodiment of FIG. 1A illustrates VDD 100 to include various components, some embodiments provide for VDD to utilize functionality from other sources. For example, the GPS component 130 can be incorporated from a driver's cellular telephony device, which can communicate with the VDD 100 using the communication component 140 and/or one of the alternative communication components 142 (e.g., a Bluetooth channel). As another example, the VDD 100 may communicate with or otherwise interface with an odometer of the vehicle on which the VDD 100 is mounted. In such a variation, VDD 100 can obtain, for example, distance traveled or trip information.

FIG. 1B illustrates a vehicle communication system that provides for a vehicle 10 that uses a VDD 100, under an embodiment. More specifically, a system 200 includes VDD 100, mounted or attached to a vehicle 10. In some embodiments, the VDD 100 is mounted to a hubcap on the vehicle. While the example shown uses only one hubcap, more or fewer hubcaps can be used. The VDD 100 communicates with a display device interface 180 using a wireless link that is established using the communication component 140 (or other component). Optionally, the VDD 100 can communicate with other display devices using the communication component 140, or a second communication component 142 (e.g., Bluetooth, WiFi, inductive link etc.).

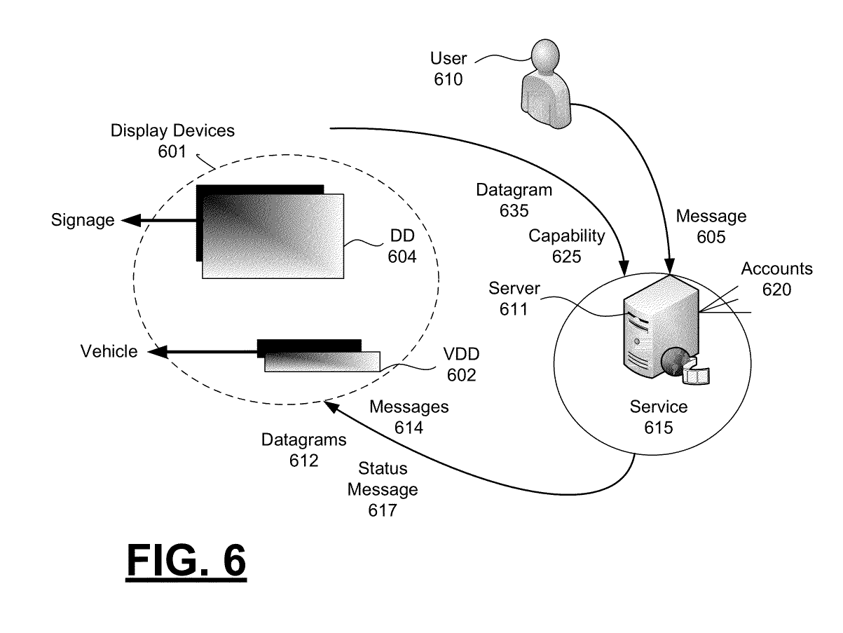

As described with some embodiments, the display device interface 180, and other server-side components, can be provided as part of a network service. As described with, for example, an embodiment of FIG. 6, a communication protocol 198 can be implemented to enable communications 199 between the service (or the display device interface 180) and the VDD 100, as well as between users and the service. As described in greater detail, the communication protocol 198 can specify parameters and fields for use in enabling the VDD 100 (or other form of display device) to communicate with a service.

In order to enable determination of exposure parameters, the VDD 100 signals, for example, GPS data, timing data (relevant times as measured from vehicle for travel, parking etc.), rotation information or other information to the display device interface 180. For example, the communication component 140 can operate with logic or resources that interface with the GPS component 130, sensors (e.g., accelerometer), verification component 150 to obtain information that is to communication, then send data packets to the display device interface 180 using, for example, a cellular channel link. The information signaled from the communication component 140 can also identify the vehicle, or the VDD 100.

The display device interface 180 can include a data store 185 that matches the received VDD/vehicle identifier to a user identifier. In some embodiments, a value determination logic 182 converts information received from individual VDD devices 100 into value using an algorithm. For example, the value determination logic 182 can determine a value based on exposure parameters, including (i) number of miles driven in a particular time period, (ii) number of miles driven during certain hours of day (e.g., rush hour, weekend, evening), (iii) amount of time the VDD 100 was exposed while moving or parked (or moving at a particular speed), (iv) location of the vehicle when parked or being driven. Resources that can be utilized by the value determination logic 182 include maps for determining exposure parameters. A user can receive compensation for the effort of driving/parking with VDD 100 based on an output of the value determination logic 182.

For example, a local store may wish to promote a new product. In order to get the word out, the store can subscribe to have commercial content, such as an image, communicated to a fleet of display devices. The local store can, for example, purchase a number of commuter hours for vehicles within a certain vicinity of the store, or alternatively within a certain region. The network service can transmit the commercial content from the local store to vehicles that satisfy the requirements of the local store operator. In some variations, the requirements of the local store operator can be geographic or location-based factors. As an addition or alternative, the requirements of the local store operator can specify a make or model of the vehicle, such as cars that are newer (e.g., less than three years old). As another example, the local store owner can specify that the commercial content of the store is to be limited to vehicles that match the user's likely demographic, such as family-based vehicles (e.g., mini-vans and sedans rather than sports cars). The service can serve the content to the vehicles over a given duration of time.

As an alternative or variation, the store operator can select a number of vehicles and/or a number of hours of exposure while the vehicle is in movement, or when the vehicle is parked. The service can select vehicles while the vehicles are in movement, or alternatively when the vehicles are parked. Thus, for example, the vehicle 10 may be equipped with a display device that rotates content, such as displaying different advertisements for when the vehicle is in motion and when the vehicle is parked.

In variations, the store owner may place a bid for purchase for advertisement units, which can be measured based on a number of display devices, number of vehicles, number of miles driven or amount of exposure time.

In some embodiments, the users can request and receive content, then generate hard copies of the content. For example, the users can print the content out and attach it to their vehicles in order to display the advertisement until the total amount of hours are used up. The advertisement can include QR codes, or other barcodes, and/or NFC tags for extra features (e.g., a bystander can see the advertisement and can take a picture of the QR code to get more information on the advertisement campaign, such as coupon for a buy one get one free for a particular product or service from a customer of the service).

In some embodiments, the service can include a portal (the front end portal) that provides an interface to enable a customer (e.g., person who uploads the advertising content) to input various settings and/or requirements. For example, the customer can select an amount of time that he or she is willing to pay for users to display the content on the users' vehicles. The customer can also set requirements for geographic locations for which he or she wants the advertisement content to be shown in, or time periods (e.g., between 8 am and 9:30 am or during commuting times) in which he or she wants the advertisement contents to be shown in. The users who are willing to print out the advertisement content and attach it to their vehicles can be notified of such requirements as well as compensation amounts when they agree to partake in the service. The users can also be notified once the various requirements are met.

The GPS component 130 can be built in to the VDD 100 (e.g., attached to the hub cap advertisement) in order to tracks where the advertisement has been displayed. In some embodiments, the VDD 100 can include QR codes, or other barcodes, and/or NFC tags for providing extra features. For example, in addition to GeoTracking, a QR code can encode GPS information so that if a person photographs the QR code, the photograph can be processed (either on the user's phone, or by a service) and decoded to reveal position or GPS information. The information (either prior to or after it is coded) can be communicated to the system portal, for example, where the information can be used to determine (i) where the advertisement was seen or displayed (e.g., when it was photographed), and (ii) conditions of the VDD 100 or the advertisement (e.g., was VDD 100 dirty etc.). In another example, a bystander can take photograph the QR code and receive a coupon or some other promotional information.

In some embodiments, the VDD 100 can include mechanisms to enable the promotional content to substantially appear right-side up when the car is moving. For example, mechanical features can be used to provide a mechanical “up” contrivance. Other mechanisms include an electronically rotating display (e.g., a rotating or semi rotating device with LEDs that light up to display content when it rotates) or other light displays. The VDD 100 can include an attachment mechanism 120, such as adhesives, or magnets to enable the VDD 100 to be attached to panels of the vehicle, the roof, or hub caps/rims.

In an illumination implementation, the VDD 100 may take the form of a solid disk. An illumination component can be placed within the wheel well to illuminate content onto the disk. The illumination component can, for example, wireless receive image content that it displays on the disk of the VDD 100.

Embodiments also include a portal for the users (or drivers), where customers and users can sign up to participate in the service. Customers can upload a number of different advertisement content for advertisement campaigns, or promotional events, and managing which geographic regions and how much time (and where) each of the users has displayed ads for a given campaign.

In some embodiments, the VDD 100 can be a dynamic hubcap display. The features of the VDD 100 can include resources to derive energy from the mechanical motion of the wheel (e.g., include means to convert mechanical energy into electrical energy). The energy can be used to, for example, illuminate the display component 165, the communication component 140, the GPS component 130, or other components of the VDD 100. In such implementations, embodiments further recognize that since the VDD 100 is powered, it can also dynamically display ads (e.g., change content displayed on an LCD array). Furthermore, embodiments recognize that since the dynamic hubcap display is powered it can use its GPS component 130 to display location-specific content. In variations, the VDD 100 can connect to the Internet or other network to down load new content.

In variations, if several the VDD 100 are near each other, each VDD 100 can coordinate its respective display for greater effect. If several VDD 100 are near each other they can interact (like winking at each other) for greater effect.

While some embodiments describe use of hubcap media, other embodiments provide for other form factors and vehicle mediums for the display of advertisement. For example, the VDD 100 can be in the form of a panel for a surface of the vehicle, such as a door panel, trunk panel etc.

System Overview

FIG. 2 illustrates a system for displaying content on vehicle display devices of vehicles, according to one or more embodiments. A system 200 can be implemented as a network service, using, for example, a server or combination of server resources. In an embodiment, system 200 includes a content delivery sub-system 210 that operates to (i) enable processes for receiving content from customers, and (ii) selecting content items for delivery to individual VDD 100. In some embodiments, the content delivery sub-system 210 operates in connection with other components and functionality, including components that maintain end user accounts, and components that determine compensation for end user based on use of their vehicles while displaying content items on VDD 100.

According to embodiments, the content delivery sub-system 210 includes a display device interface 220, a customer interface 240, a display content data store 244. The content delivery sub-system can also include, or operate with a content distribution manager 250 which uses logic to programmatically determine target VDD 100. As described in more detail, content items specified by customers can be paired to VDD 100 of persons based on various considerations, including criteria or other input specified by the customer and/or end user.

The display content data store 244 retains content items 225 provided from customers through the customer interface 240. In some embodiments, the customer interface 240 is used by advertisers, who provide content items 225. Other customers can include, for example, businesses, organizations or persons that wish to communicate a message. The customer interface 240 can be in the form of a web page, for example, in which customers register and then log-in. The customers can supply the content items 225 in the form of, for example, product images, brand images, text, coded content (e.g., bar codes, QR codes etc.). In providing the content items 225, the customer can upload the content, or link to the content (e.g., maintain a separate web page where the content item is provided or updated).

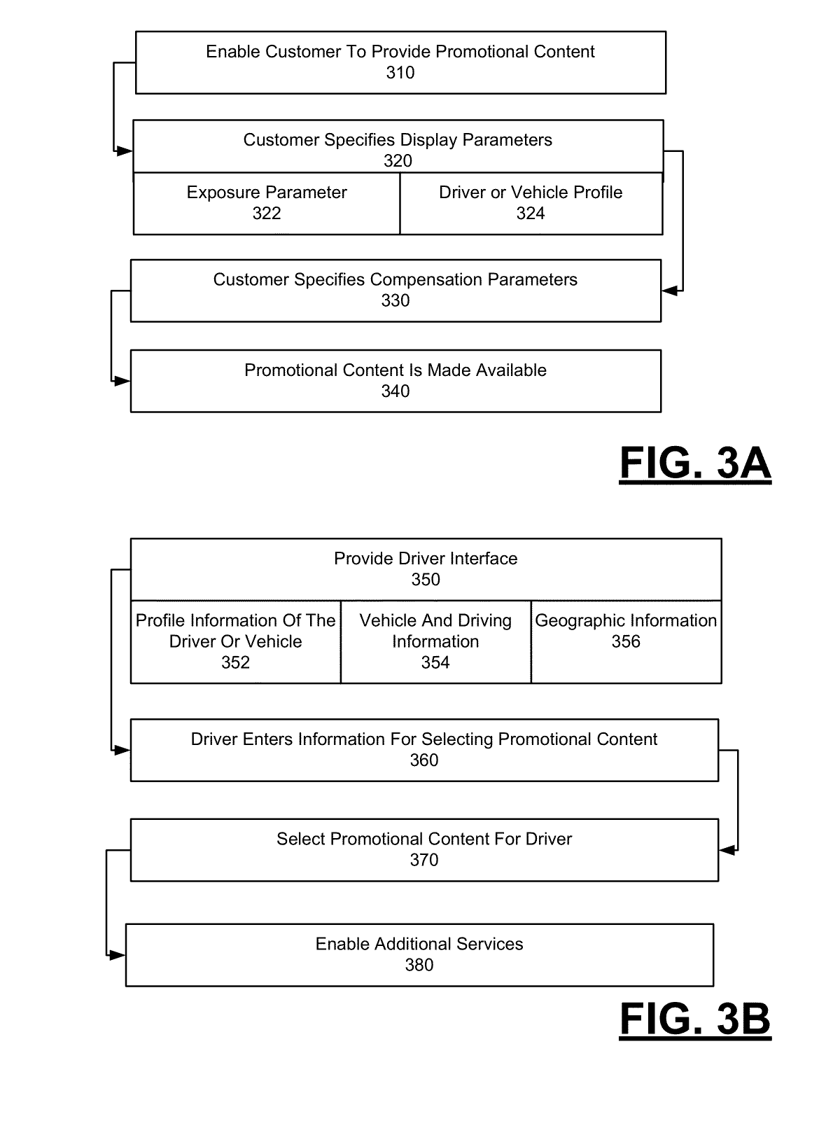

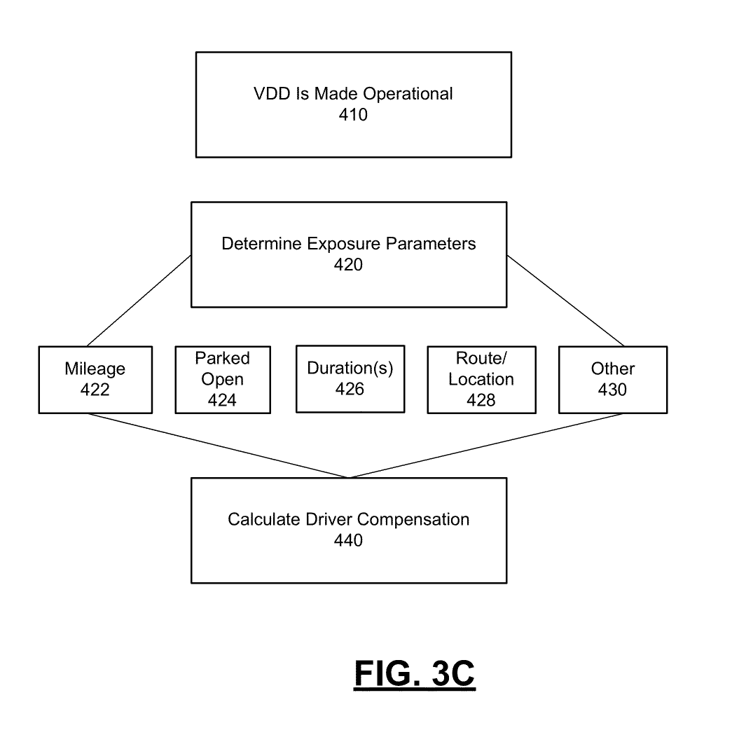

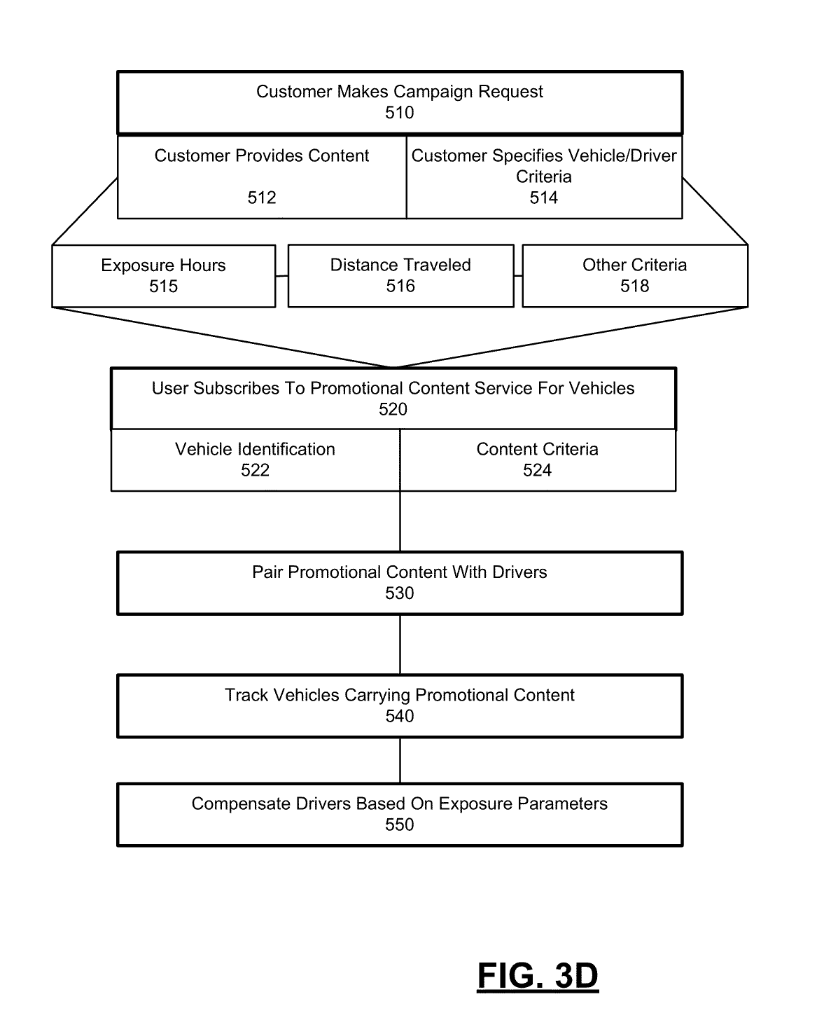

In addition to content items 225, the customer can use the customer interface 240 (or backend portal) to specify selection parameters 226. The selection parameters 226 include considerations for selecting drivers or vehicles (e.g., exposure parameters, driver or vehicle profile considerations), geographic regions for where the content items are to be displayed, and/or timing parameters for when and how long the content item 225 is to be rendered. FIG. 3A provides examples of parameters that a customer can specify in order to regulate the distribution of content items from that customer. The display content data store 244 maintains the content items 225 from the various customers, in association with parameters and information provided with the content items.

End users, or drivers, can interact with system 200 using a user interface 230 (or frontend portal). The end users can use the interface 230 to register with a service provided by system 200. In some implementations, the users register a VDD 100 with the service. For example, users may request the VDD 100 during an initial registration process. The VDD 100 can be delivered to the end user with configuration information for enabling the device to trigger on and operate for the requesting user. In variations, the end user can obtain the VDD 100 and then register their VDD 100 with the service of system 200. The information 235 specified by the end users can include (i) user information (e.g., name, demographic information, user's driving record or style), (ii) vehicle information (e.g., type of vehicle the user), and (iii) location information regarding, for example, routes the user drives, general location of the vehicle that carries the VDD 100. Such information can be used to match the user to preferences or criteria specified by the customer through the selection parameters 226.

Additionally, the end user may specify selection parameters 236 that indicate a preference of the user for displaying specific content items. For example, the user can specify (i) a set of parameters that indicate a user's preference to display geographically relevant content (e.g., advertisements for local merchants, (ii) a set of parameters that indicate a user's preference for a particular brand or set of brands, (iii) parameters that indicate a user's preference for products that the user wishes to endorse, and/or (iv) a specific content item (e.g., the user can browse from an available list and make a selection). In some variations, the end user can also specify negative preferences, such as classes of content items that the user does not wish to display or source (e.g., a brand or product that the user does not endorse, a product category that the user does not want to advertise for, etc.).

The information 235 and the selection parameters 236 provided from the end users can be stored in a user account data store 256. The user account data store 256 can be separate or integral with, for example, the resources of the display content data store 244.

The content distribution manager 250 operates to pair end users (or the individual VDD 100 that are assigned to end users) with content items 225. The pairing of content items 225 to VDD 100 may be based on both customer provided parameters (e.g., selection parameters 226) and end user provided parameters (user selection parameters 236). Accordingly, the content distribution manager 250 can access the display content data store 244 and the user account data store 256 in performing its processes for pairing VDD 100 (or end users) to content items 225.

In one implementation, the selection parameter 226 of individual customers can be referenced against user information 235 (e.g., user vehicle information, geographic information) of a group of users to identify a set of users whom satisfy the requirements of the customer. For individual content items 225, selection parameters 236 specified by each end user in the set of users can be used to filter, weight or otherwise select users to carry the content items for the particular customer. Examples for parameters that can be used to determine pairing of content items to users is provided with examples of FIG. 3A and FIG. 3B.

In some embodiments, customers specify campaigns which require, for example, advertisement units and durations of time. Advertisement units can be defined in a variety of ways. As one example, an ad unit can be defined as a single VDD 100 that displays a specific content. As another example, an ad unit can be defined by a defined duration in which a single VDD 100 displays a specific content. As a more specific example, a customer can specify 100 advertisement units for a period that lasts one week or one month. The content distribution manager 250 can operate to pair content items 225 to VDD 100/end users until, for example, the number of advertisement units are met. To further the example, the content distribution manager 250 can operate to evenly distribute advertisement units over the specified duration. Thus, for example, for a 30 day period in which 100 ad units (the ad units can correspond to, for example, VDD 100 which display the select content item for a period of a day or thirty days etc.) are to be provided (e.g., 100 VDD display content items 225 of the particular customer), the content distribution manager 250 can operate to select 3-4 VDD 100 per day. In making the selection, the available number of VDD 100 may vary. If, for example, the inventory of VDD units is ample, the content distribution manager 250 operates to select, for example, best pairings between VDD (or driver) and the customer's selection parameters 226. If, on the other hand, there is limited inventory, fewer pairings may be available, and less consideration may be made to identify the best pairings. The content distribution manager 250 may also implement rules to ensure campaign effectiveness, such as evenly distributing the content items 225 of a particular customer over a given duration.

In an embodiment, the content distribution manager 250 operates to structure the display content data store 244 (or other memory resources of the system 200). The content distribution manager 250 can output, as a result of pairing VDD 100/end user with content items 225, a set of data items 248 that collectively (i) identify a content item, (ii) associate the content item with a set of VDD 100 which display (or are selected to display) the content item, and (iii) associate a driver or user identification with the content item. More or fewer components for the set of data items 248 can also be used. For example, in some variations, a fleet identifier can also be associated with an individual content item, where the fleet identifies a fleet (e.g., designated multiple set) of VDDs 100 or vehicles which display the selected content item.

The display device interface 220 can be configured to respond to trigger signals from VDD devices 100. The VDD devices 100 can use, for example, cellular or wireless communications to access the display device interface over the Internet (e.g., over a website). The trigger signal 257 can correspond to, for example, (i) the VDD 100 being turned on or made operational by a user, and/or (ii) an event occurring signifying that the content item displayed on a particular VDD 100 is to be changed. The event can correspond to, for example, a designated passage of time (such as triggered by a completion of an ad unit), a change in the geographic location of the particular VDD, or a threshold distance being for a particular VDD 100. The event can also correspond to a manual input from the end user. For example, the end user can access a website for system 200 and specify a change, or alternatively, request the change through a mechanism provided by the VDD 100. The trigger signal 257 can identify the VDD 100 from which the signal was generated. The display device interface 220 can use the identifier 223 (e.g., of the VDD 100) specified by the trigger signal to access the display content data store 244 and identify a select content item 222 that is paired to that VDD 100. In variations, the determination as to what content item is to be displayed to the user can be made on-the-fly. For example, the identifier 223 can be referenced to the end user via the set of data items, and a process can be triggered in which a new content item is paired to the end user. Once a selected content item 222 is paired to the VDD 100, a VDD content 255 corresponding to the select content item 222 is signaled to the VDD 100 specified by the identifier 223.

According to some embodiments, a collection of VDD 100 are tracked by system 200 over a given time period. In an embodiment, the VDD tracker 260 operates to receive exposure information 265 from one or more VDD 100. The exposure information 265 can include, for example, the identifier of the VDD 100, and information that corresponds to, or can for basis of values for one or more exposure parameters. For example, the exposure information can include position information communicated from a GPS unit that is integrated or in communication with the VDD 100. The exposure information 265 can also include, for example, timing information, such as the time when position information was received. In some embodiments, the VDD tracker 260 receives and processes, for example, position information 265 from a specific VDD 100 in near real-time. In variations, the VDD tracker 260 receives and processes information from the specific VDD 100 in bursts, such as, for example, at the end of a trip for the vehicle on which the VDD 100 is mounted.

The VDD tracker 260 can identify or determine exposure parameters 267 from the exposure information 265. The exposure parameters 267 can correspond to, for example, distance traveled, current position, vehicle velocity or state information as to whether the vehicle is in motion or stationary, the current time, or the time of travel. The VDD tracker 260 can utilize various resources in determining the exposure parameters 267. For example, the VDD tracker 260 can access a map data store 262 to correlate position information with a map, with a locality, set of merchants and/or traffic patterns. Still further, the VDD tracker 260 can receive real-time traffic updates and reference the position information provided with a particular set of exposure information 265 to a specific traffic pattern.

In an embodiment, the exposure parameters 267 can be stored with a specific user profile. In this way, the exposure parameters provide, for example, values and information for determining that user's compensation. In one embodiment, the compensation determination component 252 operates to determine a compensation 254 for each user, based at least in part on the value of the exposure parameters stored with that user's profile at a particular time. Examples for determining user compensation based on exposure parameters is provided with an embodiment of FIG. 3D.

Methodology

FIG. 3A illustrates a method for operating an interface to enable advertisers to list or provide promotional content for drivers, according to an embodiment. FIG. 3B illustrates a method for enabling a driver or end user to receive content for display on a display unit of the driver, according to an embodiment. FIG. 3C illustrates a method for compensating a driver for including promotional content on a display device of the driver's vehicle, according to an embodiment. FIG. 3D illustrates a method for providing promotional content on vehicles, according to one or more embodiments.

Methods such as described by embodiments of FIG. 3A, FIG. 3B, FIG. 3C or FIG. 3D can be implemented using, for example, a system such as described by an embodiment of FIG. 2, as well as one or more components such as described with FIG. 1A or FIG. 1B. Accordingly, reference may be made to elements described with other embodiments for purpose of illustrating suitable components for performing a step or sub-step being described.

According to some embodiments, customers (e.g., advertisers) can provide promotional content for distribution on display units of vehicles. The promotional content can be in the form of, for example, advertisement, brand display, special offers etc. In some embodiments, customers can access a customer portal and specify images, text or other content for inclusion on a VDD 100. The customers can access the portal using, for example, a browser or web-based application. In some variations, customers can be provided a template to enable the customer to crop or otherwise optimally place the image on the VDD 100. For example, the VDD 100 can be circular, and a template can be provided to enhance placement of customer provided content on the circular environment.

In an embodiment, the customers are able to specify parameters that regulate, for example, where and when the customer content is displayed (320). In one embodiment, the customer specifies exposure parameters (322). Examples of exposure parameters include (i) environment in which the content is to be displayed (e.g., while vehicle is in motion, rather than parked), or (ii) the length of time the VDD 100 is to be displayed in a particular environment. As an addition or variation, the customer can specify driver or vehicle profiles (324). The driver or vehicle profile can specify, for example, the type of vehicle that is to carry the promotional content of the customer (e.g., make or model, vehicle class etc.), or information about the driver (e.g., driver's driving record, information known about the speed of vehicle when used). As an addition or alternative, the driver or vehicle profile can also include geographic information, such as the location of the vehicle when it is driven or parked, or the residence of the driver.

In some embodiments, the customer can provide compensation parameters (330). Compensation parameters include parameters that weight or otherwise determine a compensation of the driver for displaying an advertiser's promotional content on the vehicles VDD 100. As described with an embodiment of FIG. 3A, the compensation parameters can be based on exposure parameters. A customer can select to weight exposure parameters based on customer preferences. In variations, the customer can also weight or otherwise compensate drivers based on, for example, the type of vehicle on which the VDD 100 is provided (e.g., customer can pay extra for nicer or newer vehicles, or for vehicles that are driven in specific regions).

The promotional content is then made available for use with the VDD 100 of the vehicles. In an embodiment, the promotional content is selected for vehicles programmatically or otherwise, by the service, with minimal or no end user-input. In such embodiments, promotional content can be paired with VDD 100 based on parameters specified by the customer. In variations, the driver (or end user) can select promotional content, or specify parameters for enabling selection of promotional content on that driver's vehicle. Still further, both customer and driver parameters can be considered when promotional content is paired to vehicles or VDD 100.

In some implementations, the data provided by the customer is generated as part of the advertiser account, and then made available to a driver population based on input parameters of the advertiser. For example, the server of the portal can determine which areas or sets of drivers, or which particular drivers can participate based on the information provided by the customer. In one embodiment, processing the data can include providing a QR code, for example, to be provided with the printable content.

With reference to FIG. 3B, some embodiments enable the user (e.g., driver) to access an interface to register their vehicles and/or receive additional services (350). Information provided by the driver can include profile information, including the profile information of the driver (352) (e.g., driver occupation, type of vehicle, driver's style of driving and driving record), the vehicle of the driver (354) (e.g., make or model, vehicle type), and geographic information such as the location of the driver's residence, route of travels, location of work etc. (356). In embodiments in which the VDD 100 is able to receive data for the promotional content and then display it, the user may simply specify the VDD identifier (e.g., serial number). The VDD (or its media) can be pre-ordered or procured offline. Then the VDD 100 can communicate with the portal through, for example, the interface 180, which communicates a file corresponding to the promotional content. In variations, the promotional content can be in hard format (e.g, print media) and the content can be downloaded. Still further, the promotional content can be downloaded on portable memory and transferred. Still further, a user mobile device may receive the promotional content and transfer it to the VDD 100.

In some embodiments, the driver enters information for use in selecting, or facilitating pairing of driver with promotional content (360). Information provided from the driver can include, for example, one or more of (i) access to a driver interface to select content, (ii) select a sponsor or an advertiser, (iii) provide input to enable a sponsor or advertiser to select the driver, and/or (iv) specify or provide content.

According to some embodiments, the promotional content may be selected for the end user based on customer parameters, driver or end user parameters, or a combination thereof (370). For example, the driver may mount the VDD 100 to his or her vehicle, then trigger or power the VDD 100 on in order to receive selected promotional content.

In variations, additional services can be provided to the driver through the driver interface (380). As an addition or alternative, the driver interface can provide services such as viewing what promotional content is available, what promotional content is displayed in their respective neighborhoods or regions, or who is utilizing the service. Thus, for example, the drivers can view what advertisements and what customers have chosen to participate in the service. In some embodiments, the driver interface can provide additional information, such as the total amount of time the driver has displayed content, the amount or distance travelled with content, and/or the amount of compensation earned or owed to the driver.

FIG. 3C illustrates a method for rewarding a driver for use of a VDD as described with various embodiments. As described above, a driver can activate, or otherwise make operational, a VDD 100 for his or her vehicle (410). As an example, the driver can conduct a normal routine of driving (e.g., errands, to and from work) with the VDD 100 attached to his vehicle.

The VDD 100 can transmit, or otherwise communicate data corresponding to exposure parameters (420). The exposure parameters can be those needed to determine the driver's compensation level. In one implementation, the exposure parameters are communicated directly from the VDD 100 and received by a service such as described with system 200 (see FIG. 2). For example, VDD 100 can form a wireless link (e.g., cellular) and signal data to a service of system 200 (e.g., signal from the VDD 100 can be received at the interface 182). The data signaled from the VDD 100 can specify, for example, an identifier of the vehicle or the VDD 100, as well as one or more exposure parameters for determining a compensation for the driver. In some embodiments, the communication from the VDD 100 is continuous, or substantially continuous. For example, the VDD 100 can establish a persistent link with system 200. In variations, the communication from the VDD 100 can be provided periodically (e.g., hourly, daily or weekly).

The parameters can correspond to, for example, position information or mileage 412 (e.g., position tallied), parking time 414 (vehicle not moving), durations of respective time 416, route location 418 or other exposure parameter 420.

Compensation is then determined for the driver based on values of the exposure parameter 420. The compensation 420 can be in the form of monetary compensation. For example, the driver can be sent monetary compensation based on a formula that takes into account exposure parameters, the type of vehicle, the driving style, and the particular commercial content or contents selected for that vehicle. Various other compensation formulas can be utilized in the alternative. For example, the exposure parameter can correspond to either the distance driven or the amount of time in which a particular promotional content is provided on the vehicle, and the user's compensation can be based primarily or exclusively on the exposure parameters.

With reference to FIG. 3D, some embodiments recognize that vehicles are generally personal possessions for everyday drivers. As such, the particular content that a driver is willing to display can be selective to brands or products that meet the driver's approval. Likewise, embodiments recognize that customers of the service (e.g., stores, vendors) can be selective in ensuring that the product or brand is conveyed to vehicles that are representative of a desired customer base.

In the example provided by FIG. 3D, a customer makes a campaign request to render commercial content on the display devices of vehicles (510). A customer can provide content (512), which can be in the form of, for example, an image with text, a text item (e.g., slogan), and/or a code (e.g., barcode or QR code for redeeming coupon etc.). In variations, the content can include media, such as a video clip. In addition to content, the customer can specify vehicle or user criteria (514). Examples of vehicle criteria can include (i) a make, model, year or type (e.g., by chassis body, as luxury or compact etc.) of vehicle, (ii) an age range or other demographic of the user driving the vehicle (e.g., non-teenagers), and/or (iii) a geographic region where the user resides, or where the vehicle is (primarily) driven, driven during a particular day or time of day, or parked.

In some variations, the advertisement request can also specify advertisement units, in the form, of for, example, (i) exposure hours (515) (number of hours that the vehicle is on the road or exposed to the public), (ii) the distance, or number of miles driven by the users (516), or (iii) other criteria, such as the number of minutes that a vehicle is in motion, parked in a certain location, etc. (518).

A user also subscribes to the service (520). In many embodiments, the users correspond to non-commercial drivers, such as everyday commuters who drive owned or leased vehicles. In subscribing to the service, the user can specify the vehicle that the user owns and on which the display device is provided (522). Additionally, the user can optionally specify the criteria for content that is to appear with the user's vehicles (524). For example, the user can specify preferred or non-preferred brands, geographic regions, product types, or other criteria for selecting (or not selecting) content. In variations, different content items may carry different compensations, and the user can select the content that they wish to display based on the compensation level offered from the advertiser. In such an embodiment, more lucrative advertisement may have more competition from drivers. Still further, some embodiments enable the user to veto, or specify the exact content that they wish to display with their vehicles. In one implementation the users can access a website and select the content, brand or advertiser that they wish to include with their display device.

According to an embodiment, a service pairs the promotional content of the customers to drivers based on criteria specified by each of the customers and the users (530). Some variations contemplate a market based approach where desirable vehicles are more selective as to the advertisement content that is carried on the vehicle. Such desirable vehicles or users can charge more for their respective advertisements. Likewise, more desirable enterprises, brands or products can exact more interest from users.

Vehicles that carry display devices can be tracked for the durations in which they carry a specific advertisement (540). As described with, for example, an embodiment of FIG. 3C, the users can be compensated for carrying advertisement based on a variety of factors (550).

Implementation Examples

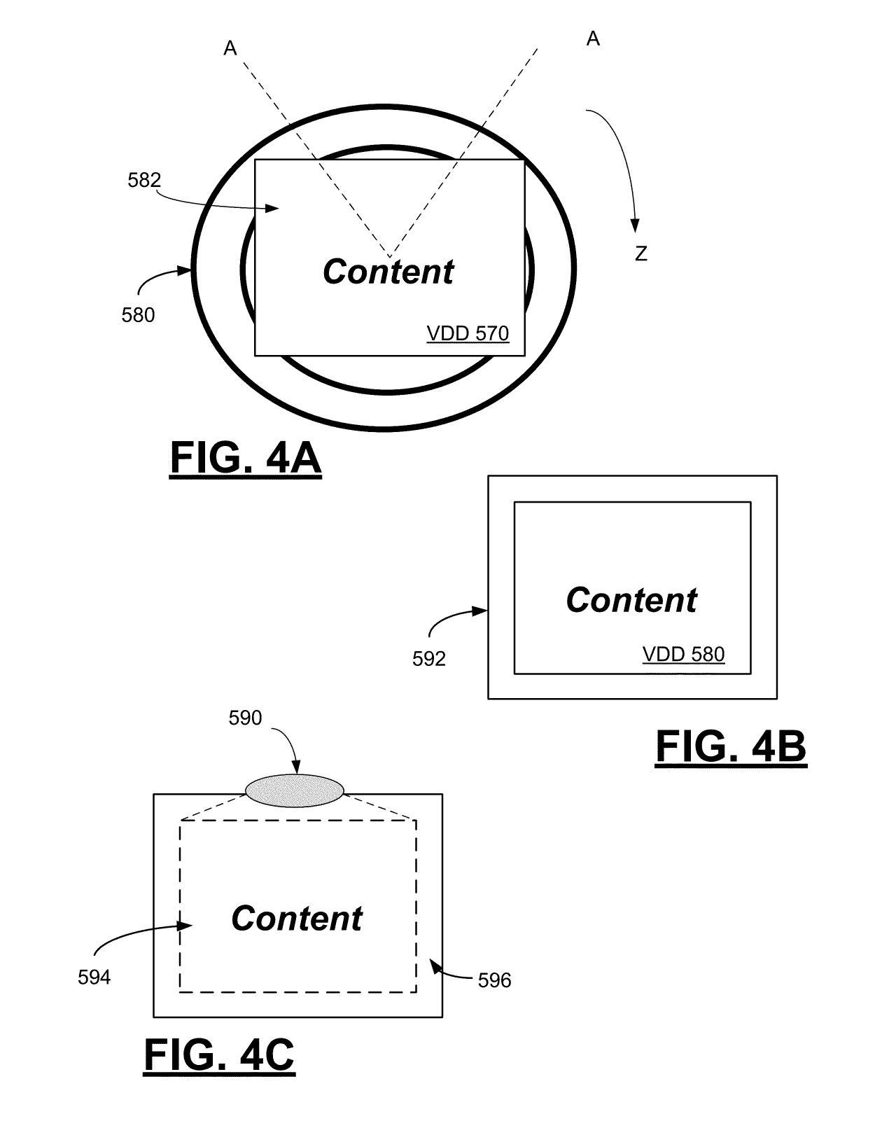

FIG. 4A illustrates an example of a VDD 100 with content provided from a service such as described with an embodiment of FIG. 2. In FIG. 2, VDD 570 is assumed to be mounted on a wheel 580 that rotates when the vehicle is in motion. In an embodiment, the VDD 570 can be configured to have limited movement as the wheel rotates. For example, the VDD 570 can be structured to remain upright while the wheel 580 rotates. The VDD 400 can maintain an upright position, signified by exemplary lines A-A, as the wheel moves. Content 582 on the VDD 400 can be received from a network service, such as provided from system 200. The content 582 can correspond to, for example, promotional content or coded content (e.g., barcodes, QR codes). In variations, the content can be personalized. For example, the VDD 570570 can carry a communication from the driver or the end user, separate or independent from the promotional content 582582.

FIG. 4B illustrates an alternative implementation in which a VDD 580 is provided as signage on a portion 592 of a vehicle that is not rotating. For example, the VDD 580 can be mounted on a door, a trunk door, or a license place region.

FIG. 4C illustrates an alternative implementation in which a VDD 590 is in the form of a projector which casts content 594 on a designated region 596 of a vehicle.

With reference to examples such as depicted by FIG. 4A through FIG. 4C, the content displayed on the various VDD 570, 580, 590 can be subjected to effects, such as movement (e.g., transition from left-to-right, or vice-versa), dissolving, or fading.

Vehicle Display Device Awareness and Communication Examples

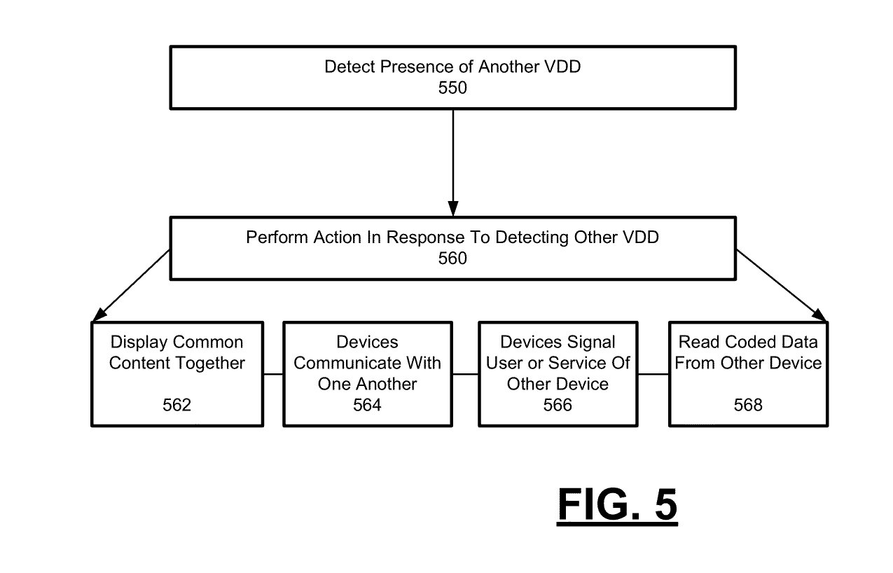

Some embodiments provide for VDDs that are configured to detect presence of other VDDs when proximate (e.g., two vehicles within ten feet or within line of sight). FIG. 5 illustrates examples for using VDDs that can detect other VDDs, according to one or more embodiments. In describing a method of FIG. 5, reference may be made to one or more elements of components described with other embodiments, such as FIG. 1A or FIG. 2, for purpose of illustrating a suitable component for performing a step or sub-step being described.

With reference to FIG. 5, a VDD 100 detects presence of another VDD (550). The VDD 100 can detect other VDD components using, for example, antenna elements and/or other communication components (e.g., Bluetooth module, see communication component 142). In one implementation, the VDD 100 can be equipped with an inductive component that can detect similar equipped components on other display devices in close proximity (e.g., in the adjacent lane of a road).

The presence detection can be subjected to certain conditions, such as when the VDD 100 is exposed or on a vehicle that is being driven. Furthermore, the presence detection can be subject to two VDDs satisfying a proximity condition, such as the two VDDs being (i) within range of short-range communication components (e.g., such as described with communication component 142 of FIG. 1A) provided with each device (e.g., between 5 and 100 feet), and/or (ii) in line of sight of one another.

In response to detecting another VDD, each VDD 100 can perform an action (560). The action performed by each VDD can be different, and based on, for example, driver preference, the content provided on the VDD that is detected, and/or the content provided on the VDD itself.

Various kinds of actions can be performed when the two VDD 100 detect one another. For example, the two VDD 100 may generate a common content (562), such as an integrated promotional content, where each VDD 100 shows a different portion of one content item. Alternatively, each VDD 100 can show a same content so that two devices are duplicative of one another. The two VDDs 100 can show a common content (or portions thereof) for a set duration, such as for a time period when the two vehicles are in proximity to one another, or for a set time period after the two devices encounter one another.

As an addition or alternative, the two VDDs 100 can exchange communications with one another (564). For example, the two VDDs 100 can exchange communicates in sequence (e.g., ping-pong). As further examples, the messages may pass driver information (e.g., identifier for driver). Alternatively, driver's may preload content or messages to communicate with other drivers.

In some variations, the communication may be in the form of a wink, where the two devices send a burst of information in a short period. For example, the two devices can send an identifier to one another (e.g., information such as an email address or social networking moniker). The communication exchange can be sequenced. For example, one of the display devices can initiate communication, any other device can accept communication, and/or optionally communicate back information. Thus, one device can send the identifier, and the other device can choose to receive it, and further choose to send back an identifier are other communication (e.g., message such as “thank you”).

As another addition or alternative, one or both VDD 100 can signal the respective drivers that another VDD was encountered (566). For example, each driver may receive a point for encountering another VDD 100. The points can be used to, for example, compensate the driver. Alternatively, the VDDs can maintain a log of other VDDs that are encountered, and communicate the log to a service such as provided by system 200. The service can count a number of times that a particular VDD 100 is encountered to, for example, increase compensation for drivers (e.g., drivers who have the most VDD 100 get additional compensation). The service may also utilize instances when VDD devices are encountered as a verification mechanism. For example, if a VDD 100 is never encountered by other devices, the service may suspect that the particular VDD 100 is not displayed properly.

As still another variation, each VDD 100 can include a code-reader (e.g., barcode reader, QR code reader) (568). The code-reader can include logic and/or firmware that can translate coded content. As an example, each VDD 100 can include a camera that captures an image of a code on another VDD 100. Each VDD 100 can display a coded content, as at least a portion of the overall content shown. Thus, each VDD 100 can read the coded content and perform an action corresponding to the coded content (528).

Communication Protocol for Display Devices

In an embodiment, a communication protocol can be implemented for a service (e.g., system hub or as shown by FIG. 2) to communicate with display devices of various forms, including vehicle display devices (e.g., VDD 100). In an embodiment, a communication protocol is provided in which fields are logically represented as simple data base table types. The transport to the client (e.g., vehicle display device) can be in a binary form with a fixed hierarchical T-L-V (Type-Length-Value) format. Among other benefits, such as transport is efficient even under low bandwidth transports such as SMS or GPRS. Furthermore, the client side processor can use a minimal, in-place, memory processor for low end clients. This can be implemented across multiple versions of the vehicle display device.

In some embodiments, the protocol includes a client identifier. Each vehicle display device can include a unique ID which is used for keeping the various VDD managed from an account and content point of view. A given car, or fleet of cars, can have multiple vehicle display devices (e.g. 1 for each wheel, more for quarter panels etc). For example, a fleet can have multiple cars each with multiple Client Displays. The management of vehicle display devices can be handled on the server side where groups of displays can be sent content in a coordinated way.

A message can accommodate small bandwidth data transports, such as SMS. Sample parameters for such a message transport include MessageID [Opt], STD(Size-Type-Data): Message-Content[ ].

A standard size (e.g., 4 byte packet) can be used for the message package.

In some implementations, a type parameter can refer to the type of data that is to be communicated. For example, both TXT and binary content can be supported by the protocol. Thus the data and format can depend on the Type parameter. The data parameter can be as simple as text EXAMPLE “Look at my cool car!” or as complex as AN animated video/picture. Exact format can be determined by Type.

The protocol can also provide an account server side data structure that includes parameters for Account-ID, Billing-Info, compensation/payment. Additional parameters can include:

User[ ]; persons who can use the account

IsAdmin [bool]—can set admin settings, billing etc

ID; ID for this user separate from email since a user may change their email

Info

First Name

Last Name

Screen-Name

email

phone

Hubs[ ]; these are the remote displays; they report what their capabilities are when they are provisioned or after each software update

ID; (for vehicle display devices)

Graphical_Attributes

Display-X

Display-Y

Display-bit-depth

Display-color-model

SupportedContentTypes[ ]; .jpeg, .png, .raw, .swf, etc

Text Attributes

Text-chars-x

Text-chars-y

The following example illustrates a message communicated from the system hub to the vehicle display devices.

S=Server

C=Client

C:ID=Client(identifier)

A:ID=Acount:ID

S,A: send(C:ID,numBytes,text/utf-8,“This is cool”)

Client: now displays “This is cool” on display.

Additional parameters can also be used to add when/where to display content. For example, the server can send content to vehicle display device which only starts displaying when a local client trigger is hit. (time of day, location etc). In variations, a server of the system portal can take care of the triggers and sends the vehicle display device the content live.

The following example illustrates vehicle display device notifying the system hub of a state update.

C: sendto (S,A:ID) message(numbyts,“GPS”,“lat-long”);

S: sendto (C:ID) message(2,“status”,“OK”);

The following example illustrates the system hub sending a service message to a vehicle display device.

S:A: send(C:ID,numBytes,text/utf-8,“fw x.y.z available”)

C: send (“OK”)

FIG. 6 illustrates an example implementation of a communication protocol for a content display system, according to one or more embodiments. A system such as described with FIG. 6 can be implemented using, for example, components and elements such as described with various embodiments provided herein. In the example provided, a communication protocol is based on the existence of display devices 601, actors 610 (e.g., users or drivers), and accounts 620.

The accounts 620 can be network (or cloud) based. For example, the network service 615 can be implemented by one or more servers 611 that maintain the accounts 620. The network service 615 can further include a website or portal for user access. Each account 620 can include or otherwise be associated with information that includes account identifier (e.g., account number), billing information, account creation data, account last used date, and account last paid date. Users are associated with accounts 620, and accounts can be associated with one or more display devices 601. The users 610 of the accounts can 620 manage the accounts using password and login information. In variations, the displays 601 can be logical as well as physical. An account can have multiple displays 601 associated with it, and can reference a display by account number or user-provided name.

As one feature, the communication protocol can include an active message field can be associated with the display device 601 of a given account 610. The active message field shows text, images or video on display for a particular display. Another field can display a current or past (or series of past) locations of a device. The user 610 can also specify tags to group displays. For example, the following tags can be assigned to a display, via an account:

tag1: License plate #

tag2: rear-plate (could also be drop down)

In some implementations, information can be sent to display devices 601 in the form of datagrams 612, using communication channels such as provided by cellular data (e.g., CPDP, GPRS, EDGE, 3G, LTE etc.). Smaller messages can be transported using, for example, SMS messages 614.

Some embodiments provide for use of multiple kinds of display devices, including devices of different form factors or usages (e.g., vehicle display device versus wall signage). For example, display devices 601 can include a vehicle display device 602 and/or an alternative signage display device 604 (e.g., wall mount), and both devices can be associated with one of the accounts 620.

Display devices 601 can also be distinguished by capabilities, particular as to processing capabilities. For example, the communication protocol may distinguish between intelligent or “dumb” display devices. Display devices 601 can also include other characteristics, such as performance characteristics, hardware capabilities, and other characteristics. Specific examples include, for example, display resolution, dimensions, color or monochrome, high-definition, video support etc.

In some implementations, the display device 601 is initiated or otherwise triggered to become online. When initiated, the display device 601 can register itself with the service 615. The service 615 can use information provided from the display device 601 to associate the display device with one of the accounts 620 maintained with the service.

Some variations provide for the display devices 601 to communicate their respective device capabilities 625 to service 615. The capabilities of the display devices 601 can include, for example, information that indicates the processing ability or intelligence of the display device. For example, either display device 602, 604 can be considered “dumb” if substantially all control comes from the service 615 (or cloud) or other resource.

In one implementation, the communication protocol provides that when the display devices 601 connect to service 615, the display device 601 signals capabilities 625, which can include (i) Serial Number of Display (globally unique ID in the universe of all possible displays and accounts, such as 160 bit SHA1); (ii) display model information, such as manufacturer name or model, firmware version, and/or hardware version; (iii) display capabilities, such as pixel information (x-width, y-height, colors per pixel), dot pitch per pixel (x pixels per cm, y pixels per cm), picture support (e.g., file format and type, text or image support, video support (e.g., frame per second, frame storage or caching), animation support (slide left-to-right or right-to-left and slide velocity (e.g., cm/s)); (iv) display hardware capabilities; and (v) display interactive capabilities (e.g., display is touch-sensitive, includes sensors etc.).

In variations, the communication protocol enables user messaging, where the user can specify input that is translated and displayed as output on the display device 601 associated with the user. Such display input can be made in real-time, or substantially in real-time.

In an embodiment, the user 610 can send a message 605 (e.g., via email or SMS) to a cloud service, which can forward or send an appropriate message (e.g., data sequence) to a corresponding display device 601. The display device 601 can be selected by the user in the message (e.g., a specific VDD 602). In variations, the display device 601 can be pre-associated with the user or the messaging identifier (e.g., cellular number). Still further, the user can enter the message 605 using a website, or some other device. Once the message is received, the service 615 can relay the message 605 to the specified display device.

The service 615 can communicate with display devices 601 using one or more communication modes. One communication mode can correspond to messages 614, such as communicated through SMS. For example, if the message 614 is a small text, then the service 615 can use SMS to send the message to save on, for example, costs. In variations, other modes of wireless communications (e.g., WiFi or Bluetooth) can be used to communicate with the display devices 601. Datagrams 612 can be communicated using, for example, cellular channels, or alternatively WiFi or Bluetooth.

In one implementation, the contents of datagram 612 (as communicated from service 615 to display device 601) can include (i) Message Type: “Update Contents” (ii) Display Serial Number (e.g., allows display to double check if it should accept), (iii) Message Hash [SHA1], which can serve as a checksum and a way for the display to authenticate the message contents, and/or (iv) Message Contents.

Some display devices 601 can also receive the datagrams 612 from other devices. For example, the VDD 602 can receive the datagram 612 from a mobile device carried by the user when in proximity to the VDD 602.

With regard to the contents, the parameters can include:

message-type—[text|picture|animation|URL . . . ].

The use of the URL can cause the display device 601, for example, to go the URL for the content (e.g. www.display-service-update.com/URL). This can be further expanded by auto provision, that each display can go to: www.display-service-update.com/auto?displayID=display-serial-num where the display device 601 will auto update itself using a URL.

Another parameter used in the communication protocol as between the service 615 and the display devices 601 can be represented by:

message-bytes[ ]—message content, of format in message-type (as described above).

Other message parameters can also include:

Display message time start—This parameter can be set to start display a content item, such as a message, on the display device 601 after a particular time. Among other benefits, use of such a parameter in a communication protocol allows for synchronized updates of a message if a large number of displays are to be updated to the same content stream.

Display Message Time End—This parameter can be set to end display a content item, such as a message, on the display device 601 after a particular time.

Display Message Location (e.g., position coordinates and distance)-only display the message when closer than the distance of the coordinates.

According to some embodiments, a communication protocol can also be implemented to enable the display device 601 to communicate datagrams 635, messages and other information to the network service 615. In communications between the display device 601 and the network service 615, the communication protocol can implement parameters for datagrams that are transmitted from the display device 601 to the service 615. These parameters can include (i) message type and display status, (ii) display serial number, (iii) current message hash, which can be computed based on content, rather than received hash, (iv) GPD coordinates, and/or (v) last message hash, in which the display device sends hash of most recently received datagram (which may or may not have been displayed). The datagrams 635 from the device to the service can also include an array or string of responses to status requests.

Another form of communication between the display device 601 and the service 615 can include an interrogation. For example, service 615 can interrogate the display device to determine what functions the display device is able or has been performing. In one implementation, service 615 can send a status message 617.

In some implementations, the communication protocol can provide for the display device 601 to send an automatic event. For example, the service 615 can instruct or configure the display device 601 to communicate an automatic event when a certain local condition as occurred with the display device 601 (e.g., display device 601 is transported to a certain coordinate or region). Specific examples of conditions that can trigger an automatic event include (i) the display device 601 reaching a location, (ii) the passage of time or timing event, (iii) the contents of the display device 601 are changed (e.g. if a time changed based update has occurred and the display has updated itself), and/or the occurrence of an interactive event. In the latter case, examples include someone seeing the display device 601 and pressing a button, or the display device 601 “seeing” (or detecting “near proximity”) of another display device.

As an alternative to communicating an event back to service 615, the display device 601 can be instructed to perform some action that is triggered on the occurrence of a condition. For example, a displayed content of the display device can be changed in response to the occurrence of a geographic event, such as the display event being in a different locality (e.g., zip code).

To accommodate such triggers, the datagram 612 from the service 615 to the display devices 601 can include (i) message type, (ii) array of triggers (e.g., set triggers), including triggers that are based on (a) GPS coordinates, distances, geofencing etc., (b) events where the content or physical setting of the display changes, and (c) interactivity events.

The datagram 635 as between the display device 601 and the service 615 can include (i) message type: “display status”, (ii) display serial number, (iii) current message hash, and (iv) array current trigger set.

The communication protocol can also provide for instances when service 615 updates the display device 601 (e.g., firmware update). To provide for such updates, the datagram 612 communicated from the service 615 can specify (i) message type: “firmware update”—send, (ii) display serial number. In the response, the datagram 635 from the display device 601 to the service 615 can specify (1) message type:“ready,” and (ii) display serial number.

A loop may be implemented until the firmware or other update is received. For example, the datagram 612 from the service 615 to the display device 601 can include (i) message type: “firmware update”, (ii) display serial number, (iii) packet #, (iv) packet total number of packets, (v) packet hash, and (vi) bytes [ ] payload.

From the display device 601, the response can provide for the datagram 635 to include (i) message type: “firmware update start”, (ii) display serial number. Then from the service 615, the datagram 612 can include (i) message type: “firmware update status,” (ii) display serial number, (iii) response code: success/fail, and if fail—error string.

Alternatives and Additions

Embodiments recognize that, as human nature, many drivers will want to approve content that is displayed on their vehicles. In the context of promotional content, such drivers may want to approve the product. Thus, the display of content items on vehicles may be part of a product sponsorship by individuals.

In some embodiments, the VDD 100 can include content that is personalized from the driver or user of the VDD 100. In some variations, the VDD 100 can link to a social network feed of the driver. Thus, for example, exposure parameters or information generated from the VDD 100 can be communicated to a social network account of the driver. The user can, for example, use the VDD 100 to post their location, post other VDD 100, or communicate their sponsorship of a particular product that is the subject of the promotional content displayed on the VDD 100. Alternatively, content from a driver's social network feed can be posted to, for example, a portion of the VDD 100.

While some embodiments described herein provide for display devices or detect proximity of other display devices, variations can be be provided in which resources of a service (e.g., service 615 of FIG. 6) detect proximity as between two display devices. For example, a server can track the location of two vehicle display devices, and notify one or both devices when the two display devices are in proximity to one another. Once in proximity, one or both display devices can perform some action, such as communicate or wink with one another.

Various components described herein can be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component, can exist on a hardware component independently of other modules/components or a module/component can be a shared element or process of other modules/components, programs or machines. A module or component may reside on one machine, such as on a client or on a server, or a module/component may be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of system provided for in this application may require use of memory, processors and network resources, including data ports, and signal lines (optical, electrical, etc.), unless stated otherwise.

Computer System

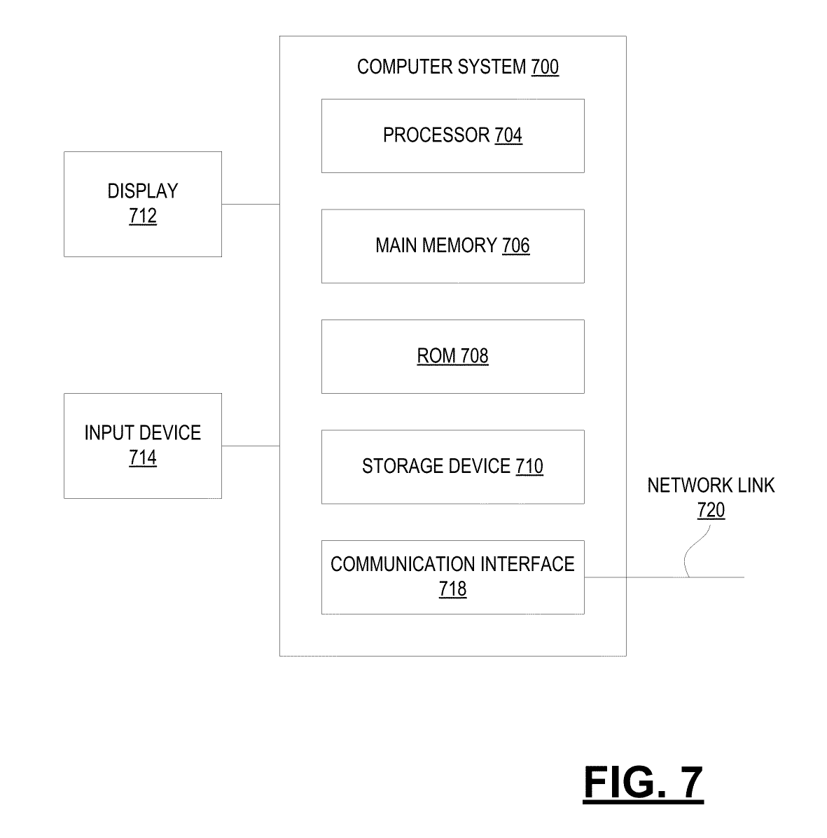

FIG. 7 is a block diagram that illustrates a computer system upon which embodiments described herein may be implemented. For example, in the context of FIG. 2, system 200 may be implemented using a computer system such as described by FIG. 7. Likewise, with the example of FIG. 6, service 615 can be implemented using the server(s) 611, which can be provided as described.

In an embodiment, computer system 700 includes processor 704, main memory 706, ROM 708, storage device 710, and communication interface 718. Computer system 700 includes at least one processor 704 for processing information. Computer system 700 also includes a main memory 706, such as a random access memory (RAM) or other dynamic storage device, for storing information and instructions to be executed by processor 704. Main memory 706 also may be used for storing temporary variables or other intermediate information during execution of instructions to be executed by processor 704. Computer system 700 may also include a read only memory (ROM) 708 or other static storage device for storing static information and instructions for processor 704. A storage device 710, such as a magnetic disk or optical disk, is provided for storing information and instructions. The communication interface 718 may enable the computer system 700 to communicate with one or more networks through use of the network link 720.

Computer system 700 can include display 712, such as a cathode ray tube (CRT), a LCD monitor, and a television set, for displaying information to a user. An input device 714, including alphanumeric and other keys, is coupled to computer system 700 for communicating information and command selections to processor 704. Other non-limiting, illustrative examples of input device 714 include a mouse, a trackball, or cursor direction keys for communicating direction information and command selections to processor 704 and for controlling cursor movement on display 712. While only one input device 714 is depicted in FIG. 7, embodiments may include any number of input devices 714 coupled to computer system 700.

Embodiments described herein are related to the use of computer system 700 for implementing the techniques described herein. According to one embodiment, those techniques are performed by computer system 700 in response to processor 704 executing one or more sequences of one or more instructions contained in main memory 706. Such instructions may be read into main memory 706 from another machine-readable medium, such as storage device 710. Execution of the sequences of instructions contained in main memory 706 causes processor 704 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A vehicle display device comprising:
a display surface;
a wireless receiver to communicate with a source;
a processing resource that receive content from the source; and
a coupling mechanism provided with the display surface to attach the display surface to the vehicle to overlay or replace a wheel surface of the vehicle.

2. The vehicle display device of claim 1, further comprising a display device.

3. The vehicle display device of claim 2, wherein the display device is one of a light-emitting display (LED) or a liquid crystal display (LCD).

4. The vehicle display device of claim 1, wherein the display surface corresponds to a hubcap of the vehicle.

5. The vehicle display device of claim 1, wherein the coupling mechanism attaches the display surface to the wheel of the vehicle.

6. The vehicle display device of claim 5, wherein the coupling mechanism is structured to enable the display surface to substantially not rotate relative to a rotation of the wheel while the vehicle is in motion.

7. The vehicle display device of claim 5, further comprising a projector mounted within a wheel well of the vehicle to project the content onto the display surface.

8. The vehicle display device of claim 1, further comprising a global positioning unit that provides positioning information for an external source.

9. The vehicle display device of claim 1, further comprising a resource that communicates with a global positioning unit that is within the vehicle.

10. The vehicle display device of claim 1, wherein the content includes an advertisement.

11. The vehicle display device of claim 1, wherein the content includes a coupon that can be transferred to a viewer of the content through use of a code that is also provided as part of the content.

12. A system for enabling communication amongst vehicles, the system comprising:
a first vehicle display device provided on an exterior of a first vehicle, configured to generate a content on a display surface;
a second vehicle display device provided on an exterior of a second vehicle, configured to generate a content on a display surface
wherein each of the first and second vehicle display devices are configured to communicate with one another when the two devices are in proximity to one another.

13. The system of claim 12, wherein the first and second vehicle display devices communicate with one another using a short range communication medium.

14. The system of claim 12, wherein the first and second vehicle display devices communicate with one another using an inductive communication link.

15. The system of claim 12, wherein the first and second vehicle display devices wink at one another in order to exchange information.

16. The system of claim 12, wherein each of the first and second vehicle display devices are configured to automatically detect one another when the two devices are in proximity to one another.

17. The system of claim 12, wherein each of the first and second vehicle display devices are configured to signal the driver of the vehicle in response to detecting an other of the first or second vehicle display devices.

18. The system of claim 12, wherein at least the first vehicle display device is configured to process a coded content;
wherein at least the second vehicle component provides a coded content; and
wherein the first vehicle component is able to process the coded content from the second vehicle component when the first and second vehicle components are in proximity to one another.

19. The system of claim 16, wherein the second vehicle display device transmits the coded content using a short range communication medium, and wherein the first vehicle display device processes the coded content by receiving a transmission from the second vehicle display device over the short range communication medium.

20. The system of claim 19, wherein the coded content is a coupon, and wherein the first vehicle display device processes the coded content by transferring the coupon to an account of a user associated with the first vehicle display device.
